(19) United States
(12) Patent Application Publication
(10) Pub. No.: US 2003/0118972 A1
(43) Pub. Date: Jun. 26, 2003

(54) Method for making a flexible chalkboard and an article made from the method

(76) Inventor: Tina P. Green, Castaic, CA (US)

Correspondence Address: PARK & SUTTON LLP, 3255 WILSHIRE BLVD, SUITE 1110, LOS ANGELES, CA, 90010, US

(21) Appl. No.: 09/975,771

(22) Filed: Oct. 12, 2001

(51) Int. Cl. G09B 11/00

(52) U.S. Cl. 434/81

(57) ABSTRACT

A method for making a flexible chalkboard begins with the step of mixing a coating compound. The coating compound includes about 1-3 parts water, about 1-5 parts talc, about 1-5 parts acrylic, and about 1-2 parts titanium dioxide. The water, talc, acrylic, and titanium dioxide are mixed together to form a solution. You apply a first application of the coating compound onto the upper surface of a fabric base. Allow the coating compound to dry on the fabric.

### BACKGROUND

The present invention relates to processes and methods for making chalkboard surfaces. More particularly the present invention pertains to methods for forming flexible chalkboards. Also, the invention applies to the article of a flexible chalkboard formed by the method.

There are many types of chalkboards available on the market and numerous processes or methods have been developed for making the various chalkboards. Very few of the methods have been applied to flexible chalkboard writing surfaces. Traditional chalkboard resins and coating materials tend to be applied to surfaces that are stiff and rigid. Most people are familiar with the original chalkboards found in schoolrooms. These chalkboards are hung on walls and flexibility of the writing surface is irrelevant.

There are flexible writing surfaces available. However, they lack the soft texture and easy folding qualities that are necessary for a children's toy that is folded and carried in a purse or backpack. Prior art devices have a writing surface with a slight stiffness. The stiffness is created by the composition of the coating and the method of applying. Traditional coating compositions for chalkboard surfaces tend to increase the fabric stiffness when applied to a flexible fabric base surface or carrier backing.

U.S. Pat. No. 4,978,568 discloses a flexible writing surface that is intended for use on the surface of a floor or like without scattering of the chalk dust particles thereon. The device can be rolled for storage. Since the device is preferably rolled, folding may cause the writing surface to retain creases or fold-lines. The device can be adapted to accommodate six or more users, thus would tend to be larger in size. A larger size device will not compactly fold for carrying in a purse.

U.S. Pat. No. 3,642,562 by Kawaguchi discloses a synthetic resin material for blackboards and the associated process. A synthetic resin with fine grains or organic material is evenly distributed in the resin, which is then spread over a flexible carrier body. The flexible carrier body can be mounted on a rigid board. The Kawaguchi patent focuses on improving the brightness contrast between the new surface of the blackboard and the used blackboard surface that has chalk particles adhering upon the surface. Kawaguchi utilizes an anti-static agent for a top coating, which minimizes the adherence of chalk particles to the blackboard during removal with an eraser. The purpose of the synthetic resin and anti-static agent coating is not to maintain a flexible carrier body. Materials and processes that focus on other objectives often fail to provide the necessary flexibility required for a foldable chalkboard surface.

To date, there is not a method of making a flexible chalkboard writing surface that effectively overcomes the slight stiffness inherent in chalkboard coating compounds. Even when slightly flexible base carrier surfaces have been used, they tend to be thicker than desirable. Thickness increases the durability of the blackboard, but tends to reduce the flexibility of the blackboard base carrier. A softer and more flexible chalk writing surface is needed that will easily fold. Additionally, the flexible writing surface should unfold without retaining creases or fold-lines on the writing surface.

Therefore, there is a need for a method of making a flexible chalkboard writing surface that is soft, flexible and easy to write upon with chalk. The softness and flexibility should enhance the ease of folding the flexible chalkboard. Additionally, the flexible writing surface should unfold without retaining creases or fold-lines on the writing surface.

### SUMMARY

The flexible chalkboard writing surface overcomes the previously mentioned disadvantage of existing methods and devices. The flexible chalkboard easily folds. Additionally, the flexible chalkboard minimizes creases or fold-lines on the chalkboard writing surface.

A further objective of the flexible chalkboard is to create a chalkcloth children's toy that is easily carried and stored in a purse or backpack. Chalkcloth fabric is easily folded into a small cloth carrying bag, which fits within a purse. Chalkcloth fabric is a soft writing surface that will occupy children's time for hours. Chalkcloth fabric is excellent for entertaining little creative minds in restaurants, doctors offices, airplanes, cars, trains, and other places with extended waiting periods. A larger chalkcloth fabric can be used that is placed upon the ground for use by more than one child. Here again, the flexibility and resistance to crease lines allows chalkcloth fabric to be folded and carried in a large purse or backpack.

Another objective of the chalkcloth fabric is providing activities that contribute significantly to a child's development. Chalkcloth fabric is a creative children's toy that provides stimulation and entertainment. Children will play for many hours with the chalkcloth fabric, which distracts them from video games and television. The chalkcloth fabric allows the child to be interactive and creative. Fabric borders can be added to the chalkcloth writing surface. The fabric borders and pieces of chalk can be provided in many different colors. Colored chalk allows the child to create more expressive multi-colored designs. Adults have a better opportunity to interact with the children when a chalkcloth fabric is the focus of the activity. In contrast, to television and other sedentary activities.

The idea relates to a method for making a flexible chalkboard and an article made from that method. The method includes the step of mixing the coating compound and various steps used in applying the coating compound on to the fabric.

The coating compound includes about 4 parts water, about 5 parts talc, 5 parts acrylic, and about 1 part titanium dioxide. The water, talc, acrylic, and titanium dioxide are mixed together to form a solution. A first application of the coating compound is applied onto the upper surface of a fabric base. Allow the first application of the coating compound to dry.

After drying, sand the coating compound. Apply a second application of the coating compound onto the fabric base surface. Allow the coating compound to dry a second time on the upper surface of the fabric. If needed after the second drying, sand the coating compound a second time and apply a third application of the coating compound to the fabric base.

In a preferred embodiment the fabric base is a “blackout” type drapery fabric. A “blackout” type drapery fabric is sufficiently thick to substantially block the passage of sunlight through the fabric. The thick fabric provides a strong and durable fabric base for applying the coating compound. Other fabrics can be used including synthetic fabrics, cotton blends, leather, and paper.

Articles made from the flexible chalkboard fabric include clothing, place mats, tablecloths and foldable chalkcloth mats. Clothing can be predominately made from the flexible chalkboard fabric or simply have a small portion of the clothing that is a flexible chalkboard fabric.

Although the present invention is briefly summarized, a fuller understanding of the invention can be obtained from the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is an enlarged side view of the fabric base with three applications of coating compound.

FIG. 2 is a top view of a lap pad.

FIG. 3 illustrates an article of chalkboard fabric attached to clothing.

FIG. 4 is a process chart of the possible steps in the method.

### DETAILED DESCRIPTION OF THE PREFERRED EMBODIMENTS

A method for making a flexible chalkboard begins with the step of mixing a coating compound that is applied to a fabric base. The coating compound includes about 1-5 parts water, about 1-5 parts talc, about 1-5 parts acrylic, and about 1-2 parts titanium dioxide. The water, talc, acrylic, and titanium dioxide are mixed together to form a solution.

Referring to FIG. 1 of the drawings, 1 designates the fabric base. 2 designates applying a first application of the coating compound onto the upper surface of the fabric base. 3 designates sanding the first application. 4 designates a second application of the coating compound. 5 designates sanding the second application. 6 designates a third application of the coating compound.

The coating compound can be mixed from the basic ingredients or purchased premixed from a manufacturer. Benjamin-Moore chalkboard paint can be used. Water can be added to the Benjamin-Moore chalkboard paint. Adding about 1 part water to between about 8 parts to about 16 parts Benjamin-Moore chalkboard paint is acceptable, without excessively diluting the solution. This ratio slightly thins the chalkboard paint for easy application on to the fabric surface. The chalkboard paint comprises water, talc, acrylic, and titanium dioxide. Additional water can be added for diluting the chalkboard paint to form the solution. A paintbrush, squeegee or spray gun is used to apply the coating compound to the fabric base.

Alternately, a polyvinyl chloride (PVC) rubber and water can be used for the coating compound. The PVC rubber and water solution can be applied in a similar manner as the solution formed from chalkboard paint and water.

Apply the first application of the coating compound to the fabric base. Allow the first application of the coating compound to dry for about two to four hours. Ambient temperature and humidity can alter the required drying time. If the coating compound manufacturer's recommendations for drying time are longer, then the manufacturer's recommendations should be followed. Prior to sanding, the coating compound should be substantially dry. Although, it is acceptable for the coating compound to be somewhat adhesive with a slight tackiness.

After drying, sand the coating compound. Apply a second application of the coating compound onto the fabric base surface. Allow the coating compound to dry a second time on the upper surface of the fabric. After the second drying, sand the coating compound a second time.

Apply a third application of the coating compound onto the upper surface of the fabric base. Allow the coating compound to dry a third time on the upper surface of the fabric.

When touching the fabric that has an application of the coating compound it should feel slightly rough and grainy to the touch. The coating compound can be lightly sanded with sandpaper. A gentle stroke with the sandpaper once over the coating compound is adequate. About medium grade to about fine grade sandpaper works well. Feel the coating compound on the fabric to perceive any areas of roughness that require additional sanding. A substantially smooth surface will suffice to prepare the fabric for a second application of the coating compound. The degree of smoothness is not overly critical to the method. A smooth final surface is easy to erase, so that new chalk mark designs can be created. A rougher surface tends to retain the small dust particles, which detract from a subsequent chalk mark design.

One application of the coating compound can be sufficient, although at least two applications are usually necessary to provide a satisfactory result. Two applications increase the thickness of the coating compound on the fabric, which eliminates any areas on the fabric that received an inadequate initial application or areas that may have been excessively sanded.

Two applications and one sanding of the coating compound are normally sufficient to provide an acceptable surface texture. A third application may be necessary if excessive graininess of the previous coatings have required extra sanding that reduces the thickness of the coating in certain spots. The third application, if necessary, is performed just the same as the second application. The third application of the coating compound is applied to the coated fabric, after the previous second coat has been sanded. The coating compound is allowed to dry. It is not necessary to sand again after the second application of the coating compound has dried.

The step of sanding the carrier surface will create dust particles. The dust particles can be removed from the fabric base surface by dusting with a cloth or dust brush, blowing air, or lifting and shaking the carrier surface. It is important to remove dust particles prior to applying the next application of coating compound. Residual particles of dust can adhere together during the subsequent application, which derogates the smoothness of the subsequent application.

The fabric that is used as the base carrier surface is a flexible material that will accept the coating compound. Preferably the upper surface of the fabric base carrier should not absorb the coating compound or allow the coating compound to leak through to the opposing side of the fabric. After the coating compound is applied multiple times to the fabric base, the fabric base should still easily fold with minimal or an absence of fold crease lines.

In a preferred embodiment the fabric base is a “blackout” type drapery fabric. This “blackout” type drapery fabric is readily available from most drapery stores. The “blackout” fabric is designed to prevent most light from entering a room, when a person is sleeping. The “blackout” fabric tends to have a tight weave with densely woven threads, thus it is more durable than other fabrics that readily allow the passage of light. The “blackout” fabric should have a fine soft upper surface that is similar to the feel and texture of brushed suede. The “blackout” fabric is available in different thickness. The thickness of the fabric is not essential, as long as the fabric folds easily with a minimum of crease lines.

The fabric base forms an underlying structure for the coating compound. Since the fabric is designed for drapery it tends to be pliable thus the fabric resists crease lines when folded. Many existing blackboard carrier surfaces are hard or slightly stiff. They are not flexible enough for use as a fabric base in this method.

A “blackout” type drapery fabric with one side being resistant to permeation by the coating compound is most advantageous. Permeation of the coating compound into the fabric base is acceptable, but it does require greater quantities of coating compound to be applied to the fabric base to compensate for the portion of coating compound that is absorbed into the fabric base. Other fabrics can be used including synthetic cloths, cotton blends, leather, and durable paper. The coating compound can be applied with a paintbrush, thin roller, squeegee, or spray gun. When using the squeegee a small amount of coating compound is poured on to the fabric then spread evenly with the squeegee.

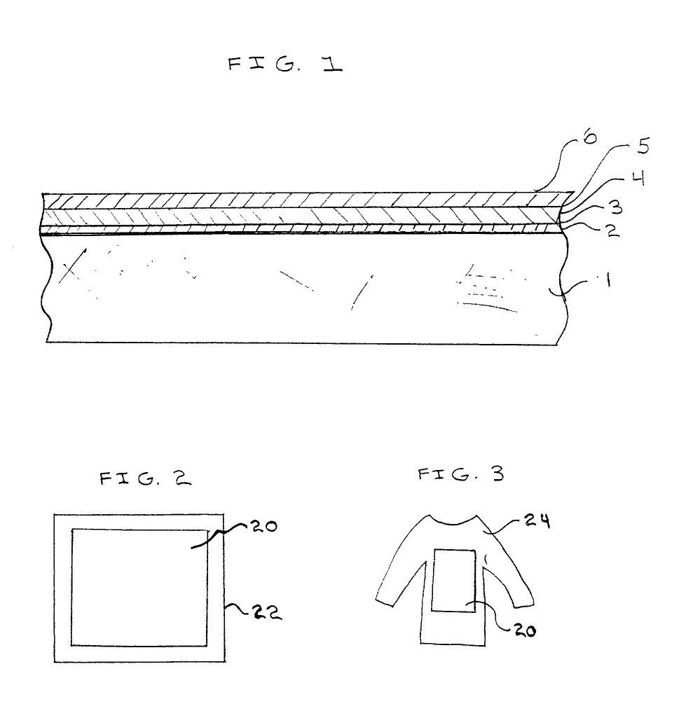

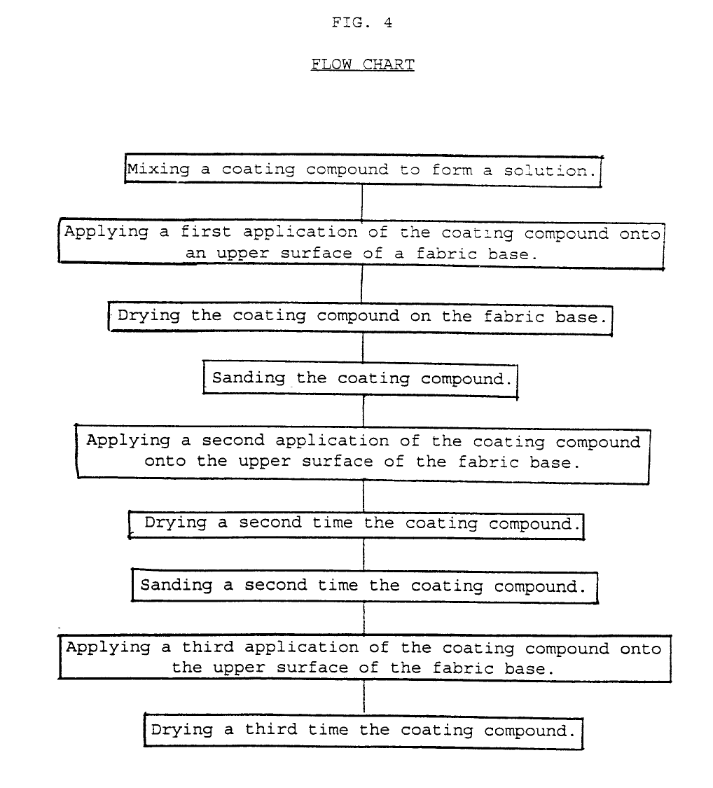

Referring to FIGS. 2 and 3, various articles can be made from the chalkcloth fabric 20 that is produced from the above method. The chalkcloth fabric 20 can be cut into varied sizes to form lap pads 22, place mats, floor mats, or table coverings. The lap pads are sized to fit conveniently into the lap of a child or adult. A stiff surface such as a book or a board can be placed in the lap under the lap pad, to create a firmer writing surface. Typical lap pads are about eleven inches by eleven inches, place mats are about nineteen inches by thirteen inches, floor mats are about twenty-two inches by twenty-eight inches, and table coverings are of greater dimensions sized to cover the table surface. The chalkcloth fabric 20 can also be used as a banner or a type of sign held up to communicate a message.

The chalkcloth fabric 20 can be attached to clothing 24. The child wearing the clothing can write notes on the chalkcloth fabric 20. Also, other children can write messages on the chalkcloth fabric 20.

Although the present invention has been described in considerable detail with regard to the preferred versions thereof, other versions are possible. Therefore, the appended claims should not be limited to the descriptions of the preferred versions contained herein.

What is claimed is:

1. A method for making a flexible chalkboard comprising the steps of:
a) mixing a coating compound comprising water, talc, acrylic, and titanium dioxide, wherein the water, talc, acrylic, and titanium dioxide are mixed together to form a solution;
b) applying a first application of the coating compound onto an upper surface of a fabric base; and
c) drying the coating compound on the fabric base.

2. The method of claim 1, further comprising the step of: sanding the coating compound, upon drying the coating compound.

3. The method of claim 2, further comprising the steps of:
a) applying a second application of the coating compound onto the upper surface of the fabric base, upon the first drying; and
b) drying a second time the coating compound.

4. The method of claim 3, further comprising the step of: sanding a second time the coating compound, upon the second drying.

5. The method of claim 4, further comprising the steps of:
a) applying a third application of the coating compound onto the upper surface of the fabric base, upon the second sanding; and
b) drying a third time the coating compound.

6. The method of claim 5, wherein the fabric is a blackout drapery fabric.

7. The method of claim 6, wherein the coating compound is about 16 parts of water, talc, acrylic, and titanium dioxide mixed with about 1 part water.

8. The method of claim 7, wherein the applying of the coating compound is performed with a brush.

9. The method of claim 7, wherein the applying of the coating compound is performed with a spray gun.

10. The method of claim 7, wherein the coating compound comprises: about 4 parts water, about 5 parts talc, about 5 parts acrylic, and about 2 parts titanium dioxide.

11. A method for making a flexible chalkboard comprising the steps of:
a) mixing a coating compound comprising polyvinyl chloride rubber and water;
b) applying a first application of the coating compound onto an upper surface of a fabric base; and
c) drying the coating compound on the fabric base.

12. The method of claim 11, further comprising the step of: sanding the coating compound, upon drying the coating compound.

13. The method of claim 12, further comprising the steps of:
a) applying a second application of the coating compound onto the upper surface of the fabric base, upon the first drying; and
b) drying a second time the coating compound.

14. The method of claim 13, wherein the fabric is a blackout drapery fabric.

15. An article of flexible chalkboard fabric material formed by the method of claim 1.

16. The article of flexible chalkboard fabric material of claim 15, wherein the article is clothing.

17. The article of flexible chalkboard fabric material of claim 15, wherein the fabric is a blackout drapery fabric.

18. An article of flexible chalkboard fabric material formed by the method of claim 5.

19. The article of flexible chalkboard fabric material of claim 18, wherein the article is a lap pad.
